(19) United States
(12) Patent Application Publication
(10) Pub. No.: US 2007/0076024 A1
(43) Pub. Date: Apr. 5, 2007

(54) Ink level detecting apparatus of ink-jet printer

(75) Inventors: Jin-wook Jeong, Yongin-si (KR); Soo-hyun Kim, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/514,932

(22) Filed: Sep. 5, 2006

(30) Foreign Application Priority Data
Oct. 4, 2005 (KR) 2005-93053

(51) Int. Cl. B41J 2/195

(52) U.S. Cl. 347/7

(57) ABSTRACT

An ink level detecting apparatus usable in an ink-jet printer includes a shrinkable ink pack provided in an ink tank, a fixed electrode installed to an upper portion of the ink tank, and a movable electrode disposed to face the fixed electrode at a predetermined distance from the fixed electrode. The movable electrode moves in a horizontal direction according to the height variation of the top surface of the shrinkable ink pack such that an overlap area between the movable electrode and the fixed electrode varies. The fixed electrode and the movable electrode generate a signal having a local maximum or a local minimum for a predetermined ink level point.

### CROSS-REFERENCE TO RELATED APPLICATIONS

This application claims the priority of Korean Patent Application No. 10-2005-0093053, filed on Oct. 4, 2005, in the Korean Intellectual Property Office, the disclosure of which is incorporated herein in its entirety by reference.

### BACKGROUND OF THE INVENTION

1. Field of the Invention

The present general inventive concept relates to an ink level detecting apparatus of an ink-jet printer, and more particularly, to an ink level detecting apparatus that includes a shrinkable ink pack having a height varying according to an amount of remaining ink and a capacitor having an electrostatic capacity varying in response to a height variation of the shrinkable ink pack.

2. Description of the Related Art

In conventional ink-jet printers, ink is supplied from an ink tank to an ink ejection unit having an ink firing head through an ink supplying passage, and droplets of the ink are fired through the ink firing head. Therefore, an ink level in the ink tank becomes lower as printing progresses.

In the conventional ink-jet printers, an amount of remaining ink (ink level) in the ink tank should be measured precisely, especially when the ink level approaches a minimum level. That is, when the amount of remaining ink is insufficient or too low, the user should be informed of this condition, and a next page should not be printed. Further, the user needs to be informed of the ink level with a sufficient time before the ink becomes insufficient to allow the user to predict a time for replacement or refill of the ink tank.

According to a thermal method of firing ink from the ink firing head, a heating unit applies heat to the ink contained in an ink cell to fire the ink by rapidly expanding the ink. In the thermal method, if the heating unit operates when no ink remains in the ink cell, the heating unit or other parts around the heating unit can be damaged. Therefore, the ink level must be reliably detected as to whether the ink reaches the minimum level so as to prevent damaging the ink firing head, and if the ink reaches the minimum level, the printing must be stopped.

For these reasons, several ink level detecting apparatuses have been developed. For example, an ink level detecting apparatus utilizing a capacitor with an electrostatic capacity varying according to the ink level is disclosed in U.S. Pat. No. 4,604,633 entitled “Ink-jet recording apparatus.” According to the disclosed apparatus, an upper electrode and a lower electrode are respectively provided on an upper inner wall and a lower inner wall of an ink cartridge to face each other. The two electrodes form a capacitor, and an ink pack is interposed between the two electrodes as an intermediate material. The ink pack shrinks as the ink in the ink pack is consumed, and the electrostatic capacitance of the capacitor varies in proportion to the shrinkage of the ink pack. Therefore, the ink level can be detected by measuring the variation of the electrostatic capacity.

However, though the electrostatic capacity varies in proportion to the ink level, the actual amount of remaining ink cannot be precisely detected because of structural deviations such as installation and connection deviations of the electrodes and electrical deviations of an input signal, a rectifying/filtering circuit, and other electrical components. Further, generally, the ink tank is initially filled with more ink than a standard ink quantity by about 10%. On the contrary, when the ink tank is refilled, an amount of refill ink is not fixed. These deviations make detection more difficult with the conventional ink detecting apparatus.

### SUMMARY OF THE INVENTION

The present general inventive concept provides an ink level detecting apparatus of an ink-jet printer, which detects an ink level through an electrostatic capacity variation between a fixed electrode and a movable electrode. Further, regardless of structural and electrical deviations during a manufacturing process, the ink level detecting apparatus precisely detects which ink level point the ink level is in.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink level detecting apparatus usable in an ink-jet printer, the ink level detecting apparatus including an ink tank including a bottom, a ceiling, and sidewalls, a shrinkable ink pack provided in the ink tank, the shrinkable ink pack including a top surface that moves down evenly as ink level in the shrinkable ink pack decreases, a fixed electrode installed to an upper portion of the ink tank, and a movable electrode disposed to face the fixed electrode at a predetermined distance from the fixed electrode, the movable electrode to move in a horizontal direction according to a height variation of the top surface of the shrinkable ink pack such that an overlap area between the movable electrode and the fixed electrode varies, wherein one of the fixed electrode and the movable electrode includes a multiple wing having a plurality of strap-shaped sub-wings extended in a direction perpendicular to a moving direction of the movable electrode and arranged at predetermined intervals in connection with each other, and the other of the fixed electrode and the movable electrode includes a strap-shaped single wing disposed in a direction parallel with the multiple wing, such that the ink level is detected from electrostatic capacitance variation sensed between the fixed electrode and the movable electrode.

The foregoing and/or other aspects and utilities of the present general inventive concept may also be achieved by providing an ink level detecting apparatus usable in an ink-jet printer, the ink level detecting apparatus including an ink tank, an ink level point detector to define at least one structurally-specified ink level point and to sense a transition of a signal which is designed to vary according to an ink level in the ink tank and to exhibit a local maximum or a local minimum each time the ink level reaches the ink level point such that the ink level point detector detects whether the ink level reaches a corresponding ink level point, and an ink level calculating unit to calculate an amount of remaining ink in the ink tank using the detected ink level point.

The ink level point detector may include an ink level signal sensing unit to periodically sense an electrical ink level signal that varies according to the ink level, a signal storing unit to temporarily store the sensed ink level signal, and a point detecting unit to detect the local maximum or the local minimum of the ink level signal by comparing an ink level signal value sensed at a current period with a previous period ink level signal value stored in the signal storing unit.

The foregoing and/or other aspects and utilities of the present general inventive concept may also be achieved by providing an ink level detecting apparatus usable in an ink-jet printer, including an ink tank to contain ink and an ink tank level point detector to generate a signal varying among a maximum level of the ink, a local minimum level, a local maximum level between the maximum level and the local minimum level, and a minimum level lower than the local minimum level to indicate a remaining level of the ink according to a consumption of the ink.

The foregoing and/or other aspects and utilities of the present general inventive concept may also be achieved by providing an ink cartridge, including a frame, a shrinkable ink bag provided in the frame to contain ink and to shrink according to a consumption of the ink, a fixed electrode provided on one of the frame and the shrinkable ink bag, and a moveable electrode provided on the other one of the frame and the shrinkable ink bag and having a second shape different from the first to form a capacitor having a capacitance that varies according to an ink level point of the ink in the shrinkable ink bag.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A and 1B are perspective views illustrating a structure and operation of an ink level detecting apparatus according to an embodiment of the present general inventive concept;

FIG. 2 is a partial side sectional view illustrating an upper portion of an ink tank of the ink level detecting apparatus of FIG. 1;

FIG. 3 is a schematic drawing illustrating shapes of a fixed electrode and a movable electrode of the ink level detecting apparatus of FIG. 1;

FIGS. 4A through 4F are schematic drawings illustrating relative points between the fixed electrode and the movable electrode of FIG. 3 depending on an ink level variation;

FIG. 5 is a graph illustrating an ink level sensor signal with respect to a relative point between a fixed electrode and a movable electrode according to an embodiment of the present general inventive concept;

FIG. 6 is a block diagram illustrating an ink level detecting apparatus according to an embodiment of the present general inventive concept; and

FIG. 7 is a block diagram illustrating an ink level detecting apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

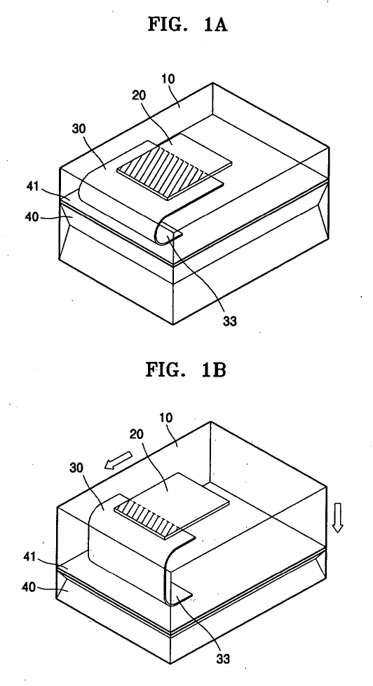

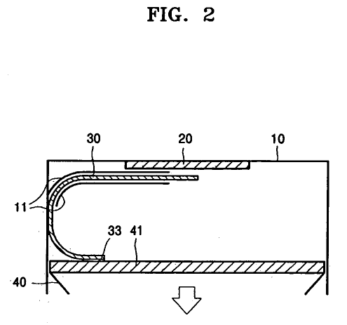

FIGS. 1A and 1B are perspective views illustrating a structure and operation of an ink level detecting apparatus usable in an image forming apparatus, such as an inkjet printer, according to an embodiment of the present general inventive. Referring to FIG. 1, the ink level detecting apparatus includes a fixed electrode 20 and a movable electrode 30 provided in an upper portion of an ink tank 10. The fixed and moveable electrodes 20 and 30 are arranged such that a relative positional relationship between the fixed and moveable electrodes 20 and 30 varies depending on a displacement of the movable electrode 30. However, a vertical relationship between the fixed electrode 20 and the movable electrode 30 are not restricted. That is, while the a portion of the moveable electrode 30 moves with the ink tank 10 in the vertical direction, a second part of the moveable electrode 30 may have a constant relationship with the fixed electrode 20 in the vertical direction.

The ink tank 10 includes a shrinkable ink pack 40. The shrinkable ink pack 40 includes an ink outlet (not shown) to supply ink to an ink ejection unit (not shown). As the ink is discharged through an ink outlet, the shrinkable ink pack 40 shrinks, and thus, a top of the shrinkable ink pack 40 moves downward. The top and a bottom of the shrinkable ink pack 40 may be formed of a film thicker than sides of the shrinkable ink pack 40 to maintain the top and bottom in a flat state. In addition, a reinforcement plate 41 may be provided on the top of the shrinkable ink pack 40 to maintain the top and bottom of the shrinkable ink pack 40 as flat.

The movable electrode 30 is extended along the side wall of the ink tank 10, and movable electrode 30 is bent in C-shape with a front end 33 fixed to the top of the shrinkable ink pack 40. If the reinforcement plate 41 is provided on the top of the shrinkable ink pack 40, the front end 33 of the movable electrode 30 may be fixed to the reinforcement plate 41 instead. Therefore, when the top of the shrinkable ink pack 40 lowers, the movable electrode 30 moves along a guide structure (not shown) formed on the top and the side wall of the ink tank 10. As a result, an area of overlap between the movable electrode 30 and the fixed electrode 20 becomes smaller.

The ink tank 10 is a housing to accommodate the shrinkable ink pack 40. Though the shape of the ink tank 10 is not restricted a bottom, ceiling, and sidewall of the ink tank 10 may be closed. The ink tank 10 may be formed of various materials. To easily form the ink tank 10 with a desired shape and structure, the ink tank 10 may be formed of plastic.

The movable electrode 30 slides in the horizontal direction at a predetermined distance from the fixed electrode 20, and the moved distance of the movable electrode 30 may be proportional to the decrease of ink level (i.e., proportional to the height variation of the shrinkable ink pack 40). The shrinkable ink pack 40 is formed of a laminated film having an aluminum layer. The shrinkable ink pack 40 includes the ink outlet to discharge the ink and at least one wrinkle on the side to cause the top surface of the shrinkable ink pack 40 to be lowered as the ink is consumed. A conventional ink pack having above-mentioned features may be used for the shrinkable ink pack 40.

Although FIGS. 1A and 1B illustrated shapes of the ink tank 10 and the shrinkable ink pack 40, the present general inventive concept is not limited thereto.

In the ink level detecting apparatus of the present general inventive concept, the fixed electrode 20 and the movable electrode 30 form a variable capacitor that has an electrostatic capacitance that varies according to the variation of the overlap area between the two electrodes 20 and 30. The two electrodes 20 and 30 are formed of conductive electrode materials. Particularly, the movable electrode 30 is formed in a film shape using a flexible, conductive material to bend along an inner wall of the ink tank 10. The flexible, conductive film material, for example, may be a metal thin plate, or a synthetic resin film having a metal thin film or a metal coating layer.

The electrostatic capacitance (C) of the capacitor satisfies the following equation. C=∈·A/d where A, d, and ∈ denote the area of overlap between the two electrodes, the distance between the two electrodes, and the dielectric constant between the two electrodes, respectively. According to the ink level detecting apparatus of the present general inventive concept, it is designed such that when the ink level reaches a certain point, the overlap area of the capacitor reaches a local minimum or a local maximum. Therefore, the local minimum or the local maximum is detected from an electrical signal generated in response to the electrical capacitance (C) of the capacitor. The electrical signal, which generated in response to the capacitance (C) of the capacitor, may be a capacitance-related signal such as an output voltage obtained from an alternating current input having a predetermined frequency.

More specifically, an output signal obtained from one of the two electrodes to input a square wave to the other of the two electrodes is used. The output signal is half-wave rectified and filtered to produce a DC voltage signal, the DC voltage signal is converted into a digital signal by an A/D converter, and the digital signal is inputted to a controller.

FIG. 2 is a partial side sectional view illustrating an upper portion of the ink tank 10 of FIG. 1. Referring to FIG. 2, a guide structure 11 is provided in the upper portion of the ink tank 10 to allow the movable electrode 30 to slide in parallel with the fixed electrode 20. When the front end 33 of the movable electrode 30, which is fixed to the reinforcement plate 41 formed on the shrinkable ink pack 40, is pulled down in a vertical direction, the guide structure 11 guides the movable electrode 30 such that the movable electrode 30 can be smoothly moved in the horizontal direction. Further, the distance between the fixed electrode 20 and the movable electrode 30 can be kept constant at the overlap area between the fixed electrode 20 and the movable electrode 30.

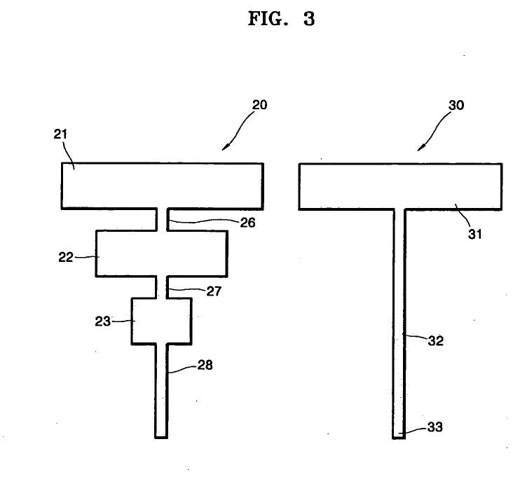

FIG. 3 is a schematic drawing illustrating shapes of the fixed electrode 20 and the movable electrode 30 of the ink level detecting apparatus of FIG. 1. Referring to FIG. 3, one of the fixed electrode 20 and the movable electrode 30 includes a multiple wing of which a plurality of sub-wings are connected with each other and arranged at predetermined intervals. Each of the sub-wings has a strap shape to protrude in a direction perpendicular to a moving direction of the movable electrode 30. The other of the fixed and moveable electrodes 20 and 30 include a single wing with a strap shape in a direction parallel with the multiple wing. For example, in the present embodiment, the fixed electrode 20 is shaped as a multiple wing having a first sub-wing 21, a second sub-wing 22, and a third sub-wing 23 that are connected with each other, and a movable electrode 30 includes one single wing 31. The plurality of sub-wings 21, 22, and 23 may have different widths. The widths of the sub-wings 21, 22, and 23 can be decreased in series depending on a location of the sub-wings 21, 22, and 23 on the fixed electrode 20 (or moveable electrode 30 if the moveable electrode 30 is provided as the multiple wing). In the present embodiment, the shapes of the fixed electrode 20 and the movable electrode 30 are interchangeable.

The sub-wings 21, 22, 23 of the fixed electrode 20 are electrically connected with each other. The fixed electrode 20 can be formed in one piece, including a first connection 26 between the first and second sub-wings 21 and 22 and a second connection 27 between the second and third sub-wings 22 and 23. The first and second connections 26 and 27 are provided to connect the sub-wings 21, 22, and 23 electrically. Further, the first and second connections 26 and 27 are provided to ensure a minimum electrostatic capacitance develops between the fixed electrode 20 and the movable electrode 30. The fixed electrode 20 may further include an extension 28 formed on a bottom of the third sub-wing 23 and has a same width as the first and second connections 26 and 27.

The movable electrode 30 may also include a flexible extension 32 extended from the single wing 31 along the guide structure 11. The flexible extension 32 has the front end 33 connected to the reinforcement plate 41 on the top of the shrinkable ink pack 40. In one embodiment of the present general inventive concept, the flexible extension 32 is not formed of the electrode material, and the flexible extension 32 is formed integral with the single wing 31.

The fixed electrode 20 of the present embodiment is fixed to the ink tank 10. The positions and intervals of the sub-wings 21, 22, and 23 are determined in association with desired ink level points to detect the amount of ink contained in the ink tank. Hereinafter, a variation of a relative position between the fixed and moveable electrodes 20 and 30 in accordance with a ink level variation, and a resulting variation of an ink level sensor signal will now be described to explain how the shapes and points of the fixed and moveable electrodes 20 and 30 are structurally characterized to detect whether the ink level reaches a preset ink level point.

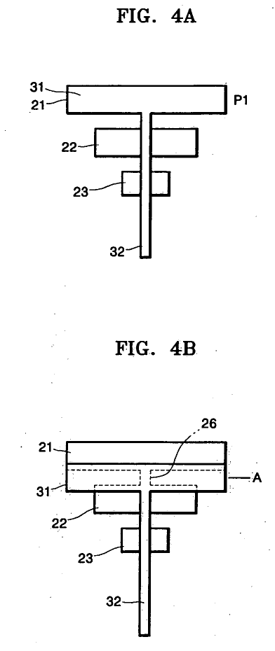

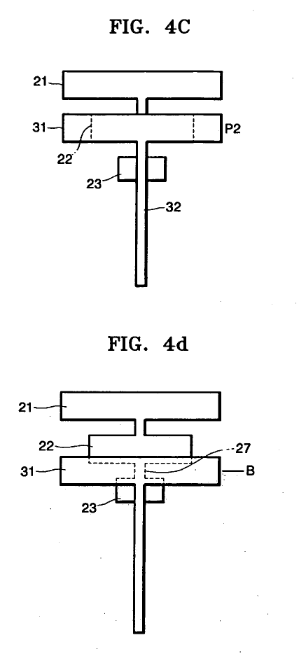

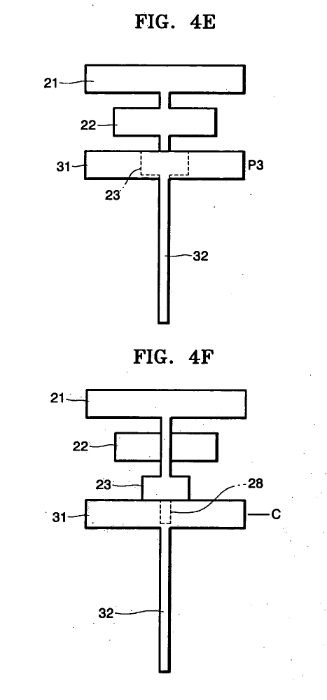

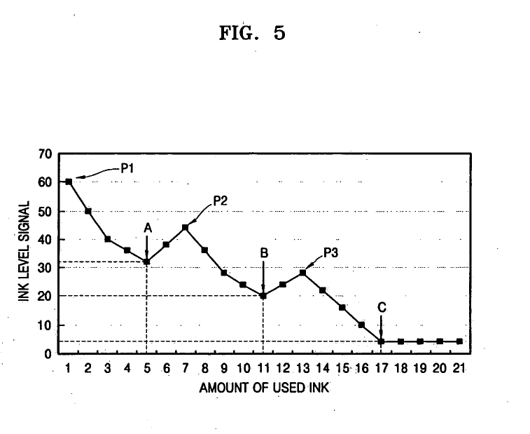

FIGS. 4A through 4F are schematic drawings illustrating relative positions between the fixed electrode 20 and the movable electrode 30 of FIG. 3 depending on the ink level variation, and FIG. 5 is a graph illustrating the ink level sensor signal with respect to the relative position between the fixed electrode 20 and the movable electrode 30 according to the present general inventive concept.

First, referring to FIGS. 4A and 5, a single wing 31 of the movable electrode 30 is overlapped with a first sub-wing 21 of the fixed electrode 20. This overlap means that the ink level is the highest. Since the first sub-wing 21 is the widest one among the sub-wings 21, 22, and 23, the area of overlap between the two electrodes 20 and 30 is maximal. Thus, the ink level sensor signal is at its maximum value P1.

As the ink level decreases, the flexible extension 32 connected to the top of the shrinkable ink pack (not shown) is pulled downward to lower the single wing 31 by the downward movement of the shrinkable ink pack 40. Therefore, the overlap area between the two electrodes 20 and 30 is reduced.

Referring to FIGS. 4B and 5, the single wing 31 is placed between the first and second sub-wings 21 and 22 of the multiple wing. At this point, the overlap area between the two electrodes 20 and 30 reaches a first local minimum, and therefore the ink level sensor signal also reaches a first local minimum A. In other words, by detecting the first local minimum A of the ink level sensor signal, it can be determined that the single wing 31 is placed between the first and second sub-wings 21 and 22. Further, the first local minimum A indicates that the actual ink level at this point reaches a first ink level point (e.g., a high level) that is structurally specified by the distance between the sub-wings 21, 22, and 23, and the placement of the fixed electrode 20.

As described above, if it is intended that the ink level points be detected when the ink level sensor signal reaches local minimums, it is adjusted such that the ink level points are detected when the single wing 31 is placed on center positions between the sub-wings 21, 22, and 23 of the multiple wing.

Similarly, it can be adjusted such that the ink level points are detected when the ink level sensor signal reaches local maximums P1, P2, and P3. In this case, each center of the sub-wings 21, 22, and 23 corresponds to each ink level point.

Referring to FIGS. 4C and 5, the single wing 31 of the movable electrode 30 is overlapped with the second sub-wing 22. The second sub-wing 22 has a width that is smaller than that of the first sub-wing 21 such that the local maximum P2 can be distinguished from the local maximum P1.

Referring to FIGS. 4D and 5, the single wing 31 of the movable electrode 30 is placed between the second and third sub-wings 21 and 22 of the multiple wing. In this point, the overlap area between the two electrodes 20 and 30 reaches a second local minimum, and therefore the ink level sensor signal also reaches a second local minimum B. In other words, upon detection of the second local minimum B of the ink level sensor signal, it can be determined that the single wing 31 is placed between the second and third sub-wings 21 and 22. Further, the second local minimum B indicates that the actual ink level reaches a second ink level point (e.g., a middle level) that is structurally specified.

Since the third sub-wing 23 has a width that is smaller than that of the first sub-wing 21, the second local minimum B is smaller than the first local minimum A. In this way, the sub-wings 21, 22, and 23 have different widths such that the ink level sensor signal can be distinguished where the ink level sensor signal corresponds to the sub-wings 21, 22, and 23.

Referring to FIGS. 4E and 5, the single wing 31 of the movable electrode 30 is overlapped with the third sub-wing 23. At this point, the ink level sensor signal reaches a third local maximum P3.

Referring to FIGS. 4F and 5, the single wing 31 of the movable electrode 30 is overlapped with the extension 28 of the fixed electrode 20 under the third sub-wing 23. The overlap area between the fixed electrode 20 and the movable electrode 30 becomes very small, and therefore the ink level sensor signal reaches a threshold value (C). Therefore, it can be understood that the actual ink level reaches the last ink level point (e.g., a low level) that is structurally specified.

In the present embodiment, the multiple wing of the fixed electrode 20 has three sub-wings to precisely detect the three ink level points P1, P2, and P3. However, a number of the ink level points and the actual ink levels corresponding to the ink level points can be adjusted by changing the shape and points of the fixed electrode 20.

Hereinafter, embodiments of an ink level detecting apparatus according to another aspect of the present invention will be described in detail.

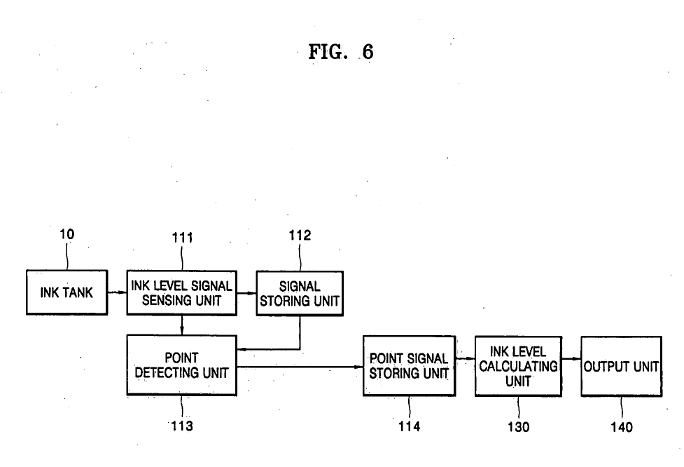

FIG. 6 is a block diagram illustrating an ink level detecting apparatus according to an embodiment of the present general inventive concept. Referring to FIG. 6, an ink level detecting apparatus includes an ink tank 10 and an ink level point detecting unit to detect whether the ink level in the ink tank 10 reaches a certain ink level point. The ink level point detecting unit includes an ink level signal sensing unit 111, a signal storing unit 112, and a point detecting unit 113. At predetermined intervals, the ink level signal sensing unit 111 senses an electrical signal generated according to an ink level. The signal storing unit 112 stores the sensed signal level. The point detecting unit 113 compares a current signal level sensed by the ink level signal sensing unit 111 with a previous signal level which is sensed by the ink level signal sensing unit 111 and stored in the signal storing unit 112 in order to determine whether the local minimum or the local maximum have passed.

The ink level signal sensing unit 111 is structurally characterized such that the signal level reaches a local maximum or a local minimum at a certain ink level point. An example of this structural characteristic has already been explained with reference to FIGS. 1A through 5.

The ink level detecting apparatus of the present embodiment can also include a point signal storing unit 114, an ink level calculating unit 130, and an output unit 140. The point signal storing unit 114 stores the sensed signal level when it is detected that the ink level passes an ink level point. The ink level calculating unit 130 calculates the ink level using the information stored in the point signal storing unit 114. The output unit 140 displays the calculated result for a user. According to the present embodiment, among the structurally-specified plural ink level points, an ink level point corresponding to the actual ink level can be precisely detected.

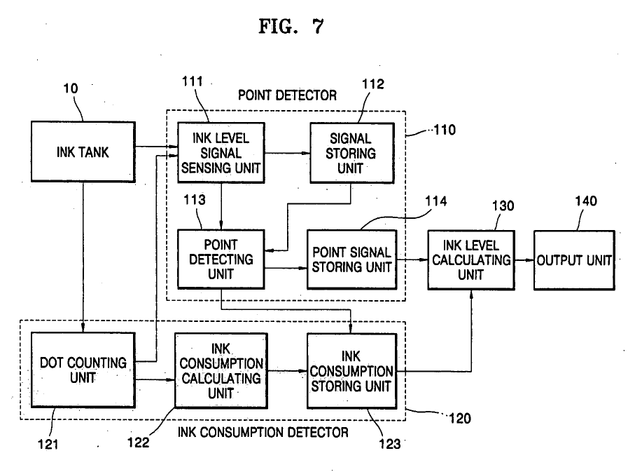

FIG. 7 is a block diagram illustrating an ink level detecting apparatus according to an embodiment of the present general inventive concept. The ink level detecting apparatus of the present embodiment includes an ink level point detector 110 that has the same configuration as the embodiment ink level detecting apparatus of FIG. 6. That is, the ink level point detector 110 includes the ink level signal sensing unit 111, the signal storing unit 112, the point detecting unit 113, and the point signal storing unit 114. The ink level detecting apparatus of the present embodiment further includes an ink consumption detector 120 to count a number of ink dots printed to measure an amount of the consumed ink. That is, printed ink dots are counted to calculate an amount of ink consumed, and this ink consumption calculation is carried out in parallel with the ink level point detection. Therefore, the ink level can be continuously detected.

The ink consumption detector 120 includes a dot counting unit 121, an ink consumption calculating unit 122 multiplies the number of counted ink dots by the mean volume of the ink dots to calculate the amount of consumed ink to, and an ink consumption storing unit 123 to store the calculated value. Signals can be periodically sensed from the ink level signal sensing unit 111 each time the dot counting unit 121 counts a predetermined number of the ink dots. Further, the ink consumption storing unit 123 may be reset when the point detecting unit 113 detects that the ink level passes an ink level point.

An ink level calculating unit 130 calculates the ink level from information stored in the point signal storing unit 114 and the ink consumption storing unit 123. The output unit 140 continuously outputs the calculated ink level.

As described above, according to the present general inventive concept, an ink level detecting apparatus detects an ink level through an electrostatic capacitance variation between a fixed electrode and a movable electrode. Further, regardless of structural and electrical deviations during a manufacturing process, the ink level detecting apparatus can precisely detect whether the ink level reaches a predetermined ink level point.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink level detecting apparatus usable in an ink-jet printer, the ink level detecting apparatus comprising:
an ink tank including a bottom, a ceiling, and sidewalls;
a shrinkable ink pack provided in the ink tank, the shrinkable ink pack including a top surface that moves down evenly as ink level in the shrinkable ink pack decreases;
a fixed electrode installed to an upper portion of the ink tank; and
a movable electrode disposed to face the fixed electrode at a predetermined distance from the fixed electrode, the movable electrode to move in a horizontal direction according to a height variation of the top surface of the shrinkable ink pack such that an overlap area between the movable electrode and the fixed electrode varies,
wherein:
one of the fixed electrode and the movable electrode includes a multiple wing having a plurality of strap-shaped sub-wings extended in a direction perpendicular to a moving direction of the movable electrode and arranged at predetermined intervals in connection with each other, and
the other of the fixed electrode and the movable electrode includes a strap-shaped single wing disposed in a direction parallel with the multiple wing, such that the ink level is detected from electrostatic capacitance variation sensed between the fixed electrode and the movable electrode.

2. The ink level detecting apparatus of claim 1, wherein the sub-wings of the multiple wing have different widths.

3. The ink level detecting apparatus of claim 1, wherein the multiple wing is arranged such that each center of the sub-wings or each interval between the sub-wings corresponds to each ink level point to be detected.

4. The ink level detecting apparatus of claim 1, wherein:
the ink tank comprises a guide structure to allow the movable electrode to slide in a direction parallel to the fixed electrode; and
the movable electrode horizontally moves along the guide structure and comprises a front end in the moving direction, the front end being flexibly extended along the ceiling and the sidewall of the ink tank and fixed to the top surface of the shrinkable ink pack.

5. The ink level detecting apparatus of claim 1, wherein the shrinkable ink pack comprises a reinforcement plate on the top surface of the shrinkable ink pack to keep the top surface flat.

6. The ink level detecting apparatus of claim 5, wherein the front end of the movable electrode is fixed to the reinforcement plate.

7. The ink level detecting apparatus of claim 1, wherein the movable has a film shape and is formed from a flexible conductive material.

8. An ink level detecting apparatus usable in an ink-jet printer, the ink level detecting apparatus comprising:
an ink tank;
an ink level point detector to define at least one structurally-specified ink level point and to sense a transition of a signal to vary according to an ink level in the ink tank and to exhibit a local maximum or a local minimum each time the ink level reaches the ink level point such that the ink level point detector detects whether the ink level reaches a corresponding ink level point; and
an ink level calculating unit to calculate an amount of remaining ink in the ink tank using the detected ink level point.

9. The ink level detecting apparatus of claim 8, wherein the ink level point detector comprises:
an ink level signal sensing unit to periodically sense an electrical ink level signal that varies according to the ink level;
a signal storing unit to temporarily store the sensed ink level signal; and
a point detecting unit to detect the local maximum or the local minimum of the ink level signal by comparing an ink level signal value sensed at a current period with a previous period ink level signal value stored in the signal storing unit.

10. The ink level detecting apparatus of claim 9, wherein the ink level signal sensing unit comprises:
a fixed electrode installed in an upper portion of the ink tank; and
a movable electrode disposed to face the fixed electrode at a predetermined distance from the fixed electrode, the movable electrode moving in a horizontal direction according to a variation of the ink level to vary an overlap area between the fixed electrode and the movable electrode,
wherein:
one of the fixed electrode and the movable electrode includes a multiple wing of which a plurality of strap-shaped sub-wings are extended in a direction perpendicular to the moving direction of the movable electrode and arranged at predetermined intervals in connection with each other; and
the other one of the fixed electrode and the movable electrode comprises a strap-shaped single wing disposed in a direction parallel with the multiple wing.

11. The ink level detecting apparatus of claim 10, wherein the sub-wings of the multiple wing have different widths.

12. The ink level detecting apparatus of claim 10, wherein the multiple wing is arranged such that each center of the sub-wings or each interval between the sub-wings corresponds to each ink level point to be detected.

13. The ink level detecting apparatus of claim 10, wherein a signal sensed between the two electrodes is an output voltage obtained from an alternating current input having a predetermined frequency.

14. An ink level detecting apparatus usable in an ink-jet printer, the ink level detecting apparatus comprising:
an ink tank;
an ink level point detector to define at least one structurally-specified ink level point and to sense a transition of a signal to vary according to an ink level in the ink tank and to exhibit a local maximum or a local minimum each time the ink level reaches the ink level point such that the ink level point detector detects whether the ink level reaches a corresponding ink level point;
an ink consumption detector to count the number of ink dots printed by ink fired from a print head to calculate an amount of ink consumed from one ink level point to another ink level point; and
an ink level calculating unit to calculate the ink level by subtracting the consumed amount of ink calculated by the ink consumption detector from the ink level point detected by the ink level point detector.

15. The ink level detecting apparatus of claim 14, wherein the ink consumption detector comprises:
a dot counting unit to count the number of ink dots printed;
an ink consumption calculating unit to calculate the amount of ink consumed; and
an ink consumption storing unit to store the amount of ink calculated,
wherein the ink consumption storing unit is reset each time the ink level reaches a new ink level point.

16. The ink level detecting apparatus of claim 14, wherein the ink level point detector comprises:
an ink level signal sensing unit to periodically sense an electrical ink level signal that varies according to the ink level;
a signal storing unit to store the sensed ink level signal temporarily; and
a point detecting unit to detect the local maximum or the local minimum of the ink level signal by comparing an ink level signal value sensed at a current period with a previous period ink level signal value stored in the signal storing unit.

17. The ink level detecting apparatus of claim 16, wherein the ink level signal sensing unit comprises:
a fixed electrode provided at an upper portion of the ink tank; and
a movable electrode disposed to face the fixed electrode at a predetermined distance from the fixed electrode, the movable electrode to move in a horizontal direction according to variation of the ink level to vary an overlap area between the fixed electrode and the movable electrode,
wherein one of the fixed electrode and the movable electrode includes a multiple wing of which a plurality of strap-shaped sub-wings are extended in a direction perpendicular to the moving direction of the movable electrode and arranged at predetermined intervals in connection with each other, and the other one of the fixed electrode and the movable electrode includes a strap-shaped single wing disposed in a direction parallel with the multiple wing.

18. The ink level detecting apparatus of claim 17, wherein the sub-wings of the multiple wing each have a different widths.

19. The ink level detecting apparatus of claim 17, wherein the multiple wing is arranged such that each center of the sub-wings or each interval between the sub-wings corresponds to each ink level point to be detected.

20. The ink level detecting apparatus of claim 17, wherein the signal sensed between the two electrodes is an output voltage obtained from an alternating current input having a predetermined frequency.

21. An ink cartridge, comprising:
a frame;
a shrinkable ink bag provided in the frame to contain ink and to shrink according to a consumption of the ink;
a fixed electrode provided on one of the frame and the shrinkable ink bag; and
a moveable electrode provided on the other one of the frame and the shrinkable ink bag and having a second shape different from the first to form a capacitor having a capacitance that varies according to an ink level point of the ink in the shrinkable ink bag.

22. The ink cartridge of claim 21, further comprising:
a guide provided on the frame to guide the moveable electrode to maintain a gap with the fixed electrode while changing an overlap area corresponding to the capacitance.

23. The ink cartridge of claim 21, wherein:
the first shape and the second shape comprise a first extension formed in a direction and a second extension extended from the first extension in a second direction having an angle with the direction; and
one of the first shape and the second shape further comprising one or more sub-wings extended from the second extension in a third direction having an angle with the second direction.

24. The ink cartridge of claim 23, wherein the one or more sub-wings are space-apart from each other in the second direction by a distance, and the distance is shorter than a thickness of the first extension in the second direction.

25. The ink cartridge of claim 23, wherein the one or more sub-wings comprises a first sub-wing and a second sub-wing having a first length and a second length in the direction, respectively.

26. The ink cartridge of claim 23, wherein a signal corresponding to the capacitance varies from a maximum level, a local minimum level, and a minimum level in order according to a variable overlap between the first shape and the second shape.
